(19) United States
(12) Patent Application Publication
(10) Pub. No.: US 2026/0356242 A1
(43) Pub. Date: Nov. 12, 2026

(54) CONTROL DEVICE, OPERATION MANAGEMENT SYSTEM, CONTROL METHOD, AND CONTROL PROGRAM

(71) Applicant: MITSUBISHI HEAVY INDUSTRIES, LTD., Tokyo (JP)

(72) Inventors: Akira Yasugi, Tokyo (JP); Hiroki Murata, Tokyo (JP); Jinichiro Goto, Tokyo (JP); Masaaki Minami, Tokyo (JP)

(73) Assignee: MITSUBISHI HEAVY INDUSTRIES, LTD., Tokyo (JP)

(21) Appl. No.: 19/130,671

(22) PCT Filed: Aug. 31, 2023
(86) PCT No.: PCT/JP2023/032029

§ 371 Date: May 16, 2025

(30) Foreign Application Priority Data
Nov. 21, 2022 (JP) 2022-185824

(51) Int. Cl. B60L 58/13; B60L 53/50

(52) U.S. Cl. CPC B60L 58/13; B60L 53/50

(57) ABSTRACT

Provided are a control device, an operation management system, a control method, and a control program that perform control so that a storage battery is prevented from being fully charged. A control device (50) is provided in a moving body, the operation route of which is predetermined, and controls the charging of a storage battery for driving a motor of the moving body. The control device (50) comprises: a distance calculation unit (53) that calculates an operation distance to the destination of the moving body; a speed acquiring unit (54) that acquires the average operation speed of the moving body; a congestion time acquiring unit (55) that acquires congestion time; a boarding and alighting time acquiring unit (56) that acquires boarding and alighting time; and a charging time calculation unit (57) that calculates charging time needed to charge the storage battery. The control device (50) calculates a standard charging amount on the basis of the operation distance, calculates a necessary charging amount by correcting the standard charging amount on the basis of at least any one of the average operation speed, the congestion time, the boarding and alighting time, and the charging time, calculates the state of charge of the storage battery from the necessary charging amount, and performs control so as to perform charging up to the state of charge from a stationary electricity storage device or a grid.

### DESCRIPTION

### Technical Field

The present disclosure relates to a control device, an operation management system, a control method, and a control program.

### Background Art

A system is known in which power is stored in a storage battery of a charging station through solar power generation in addition to a commercial power supply, and a storage battery of an electric vehicle is charged.

PTL 1 and PTL 2 disclose a system in which a storage battery of a charging station is charged using a commercial power supply and solar power generation, and the storage battery is used to charge a vehicle battery of an electrified vehicle.

In addition, PTL 3 discloses that a storage battery of a charging station stores power using grid power at night and new energy during the day and then is used to charge a storage battery of an electric vehicle.

PTL 4 discloses that a power generation amount of solar power generation is predicted, and charge and discharge control of a storage battery of an electric vehicle is performed.

PTL 5 discloses that, at night, a vehicle-use battery of a battery station is used as a power source to charge other vehicle-use batteries, while during the day, solar power generation is used to charge the vehicle-use battery.

### CITATION LIST

### Patent Literature

[PTL 1] Japanese Unexamined Patent Application Publication No. 2022-89634

[PTL 2] Japanese Unexamined Patent Application Publication No. 2021-170888

[PTL 3] Japanese Unexamined Patent Application Publication No. 2010-252587

[PTL 4] Japanese Unexamined Patent Application Publication No. 2010-268576

[PTL 5] Japanese Unexamined Patent Application Publication No. 2015-15827

### SUMMARY OF INVENTION

### Technical Problem

A storage battery tends to degrade more rapidly when operated or kept on standby with a high state of charge (SOC), particularly when fully charged (SOC of 100), as compared to a low SOC. However, PTLs 1 to 5 do not address control of a vehicle-use storage battery to avoid full charging.

The present disclosure has been made in view of such circumstances, and an object of the present disclosure is to provide a control device, an operation management system, a control method, and a control program that perform control to suppress full charging of a storage battery.

### Solution to Problem

In order to achieve the above-described object, a control device, an operation management system, a control method, and a control program of the present disclosure employ the following means.

According to the present disclosure, there is provided a control device that controls charging of a storage battery for driving a motor of a moving body with a predetermined operation route, the storage battery being provided in the moving body, the control device including: a distance calculation unit that calculates an operation distance to a destination of the moving body; a speed acquisition unit that acquires an average operation speed of the moving body; a congestion time acquisition unit that acquires a predicted congestion time; a boarding and alighting time acquisition unit that acquires a predicted boarding and alighting time; and a charging time calculation unit that calculates a charging time required to charge the storage battery, in which a reference charging amount is calculated based on the operation distance, the reference charging amount is corrected based on at least one of the average operation speed, the congestion time, the boarding and alighting time, and the charging time to calculate a required charging amount, and a state of charge of the storage battery is calculated based on the required charging amount, and control is performed such that the storage battery is charged to the state of charge from a stationary power storage device or a grid.

According to the present disclosure, there is provided an operation management system including the control device mentioned above, in which operations of a plurality of moving bodies with predetermined operation routes are managed.

According to the present disclosure, there is provided a control method of controlling charging of a storage battery provided in a moving body with a predetermined operation route, the control method being executed by a computer, including: a distance calculation step of calculating an operation distance to a destination of the moving body; a speed acquisition step of acquiring an average operation speed of the moving body; a congestion time acquisition step of acquiring a predicted congestion time; a boarding and alighting time acquisition step of acquiring a predicted boarding and alighting time; and a charging time calculation step of calculating a charging time required to charge the storage battery, in which a reference charging amount is calculated based on the operation distance, the reference charging amount is corrected based on at least one of the average operation speed, the congestion time, the boarding and alighting time, and the charging time to calculate a required charging amount, and a state of charge of the storage battery is calculated based on the required charging amount, and control is performed such that the storage battery is charged to the state of charge from a stationary power storage device or a grid.

According to the present disclosure, there is provided a control program for causing a computer to execute the control method mentioned above.

### Advantageous Effects of Invention

According to the present disclosure, the storage battery of the moving body is charged to a state of charge corresponding to the required charging amount, which is a required minimum charging amount, rather than being fully charged, thereby making it possible to suppress a rate of degradation of the storage battery. Additionally, the required charging amount can be set to a more accurate value.

### BRIEF DESCRIPTION OF DRAWINGS

FIG. 1 is a diagram showing a charging and discharging system in some embodiments of the present disclosure.

FIG. 2 is a diagram showing an example of a hardware configuration of a control device in some embodiments of the present disclosure.

FIG. 3 is a diagram showing an example of a function of the control device in some embodiments of the present disclosure.

FIG. 4 is a diagram showing a control flowchart of the control device in some embodiments of the present disclosure.

FIG. 5 is a graph showing a relationship between a power generation amount of renewable energy and a target state of charge in some embodiments of the present disclosure.

FIG. 6 is a diagram showing a control flowchart of the control device in some embodiments of the present disclosure.

FIG. 7 is a diagram showing a control flowchart of the control device in some embodiments of the present disclosure.

FIG. 8 is a graph showing a power generation amount of the renewable energy and a demanded power amount of the storage battery in some embodiments of the present disclosure.

FIG. 9 is a schematic diagram showing a route of a moving body and a position of a power storage device in some embodiments of the present disclosure.

### DESCRIPTION OF EMBODIMENTS

Hereinafter, an embodiment of a control device, an operation management system, a control method, and a control program according to the present disclosure will be described with reference to the drawings.

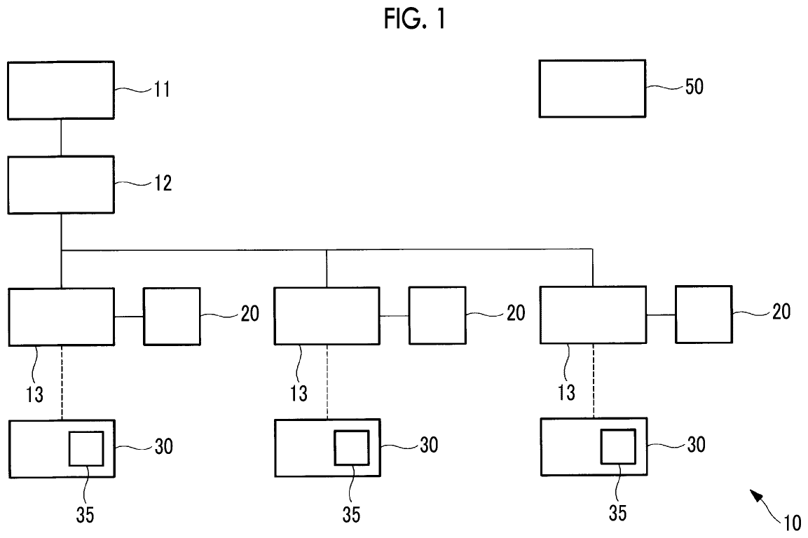

FIG. 1 is a diagram showing a charging and discharging system in some embodiments of the present disclosure.

As shown in FIG. 1, a charging and discharging system 10 of the present embodiment includes a renewable energy (power generation facility) 11, a grid 12, a charging station 13 including a power storage device 20, and a control device 50.

The renewable energy 11 is, for example, a solar power generation facility and may be other power generation facilities such as a wind power generation facility or a geothermal power generation facility.

The grid 12 is a transmission and distribution network owned by power companies or the like, through which power generated by power producers and other power retailers is delivered (supplied) to consumers. In the present embodiment, the grid 12 mainly delivers power generated by the renewable energy 11 to the consumers.

The charging station 13 is a facility including the power storage device 20 that stores the power supplied from the grid 12. In the present embodiment, a plurality of charging stations 13 are provided. A moving body 30 stops at the charging station 13, and a storage battery 35 provided in the moving body 30 and used to drive a motor (not shown) of the moving body 30 is charged. The storage battery 35 is charged with the power from the grid 12 or the power storage device 20 at the charging station 13. In the present embodiment, the moving body 30 is an electric vehicle, particularly an electric bus, and more specifically, an electrified route bus (electric route bus) operated based on a preset schedule. The moving body 30 is not limited to an electric vehicle, and may be another vehicle, a ship, an aircraft, or the like as long as the moving body 30 includes the storage battery 35. Since the moving body 30 of the present embodiment is an electric route bus, it is assumed that an operation plan such as a traveling route, traveling start and end times, and stops is set in advance. For example, when the renewable energy 11 is generating power, the power storage device 20 and the storage battery 35 of the moving body 30 may be charged with the power delivered to the grid 12, and during a time slot when the renewable energy 11 is not generating power or during a time slot when power consumption is high (when demanded power in the grid 12 exceeds the power generated by the renewable energy 11), power may be supplied from the power storage device 20 to the grid 12 or the storage battery 35 of the moving body 30.

The control device 50 performs control of the charging and discharging system 10, particularly charge and discharge control of the power storage device 20 and the storage battery 35. The control device 50 controls the charging of the storage battery 35 using a state of charge (hereinafter, referred to as an SOC).

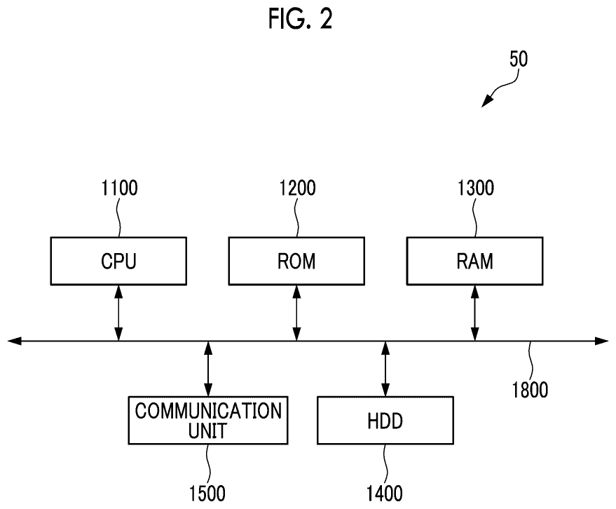

FIG. 2 is a diagram showing an example of a hardware configuration of the control device in some embodiments of the present disclosure.

As shown in FIG. 2, the control device (controller) 50 is a computer system and includes, for example, a central processing unit (CPU: processor) 1100, a secondary storage (ROM: memory) 1200, a main memory (RAM) 1300, a hard disk drive (HDD) 1400 as a large-capacity storage device, and a communication unit 1500 for connecting to a network or the like. Alternatively, a solid-state drive (SSD) may be used as the large-capacity storage device. Each of these units is connected through a bus 1800.

For example, the CPU 1100 controls the entire control device 50 using an operating system (OS) stored in the secondary storage 1200 connected through the bus 1800 and executes various types of processing by executing various programs stored in the secondary storage 1200. One or a plurality of CPUs 1100 may be provided and implement the processing in cooperation with each other.

For example, the main memory 1300 is configured with a writable memory such as a cache memory or a random-access memory (RAM) and is used as a work area for operations such as reading execution programs of the CPU 1100 and writing processing data of the execution programs.

The secondary storage 1200 is a non-transitory computer-readable storage medium. The secondary storage 1200 is, for example, a magnetic disk, a magneto-optical disk, a CD-ROM, a DVD-ROM, a semiconductor memory, or the like. Examples of the secondary storage 1200 include a read-only memory (ROM), a hard disk drive (HDD), a solid-state drive (SSD), a flash memory, and the like. The secondary storage 1200 stores, for example, an OS for controlling an entire information processing device, such as Windows (registered trademark), iOS (registered trademark), and Android (registered trademark), a basic input/output system (BIOS), various device drivers for hardware operations of peripheral devices, various types of application software, various pieces of data and files, and the like. Additionally, the secondary storage 1200 stores a program for implementing various types of processing and various pieces of data required to implement the various types of processing. A plurality of secondary storages 1200 may be provided, and the program and the data as mentioned above may be divided and stored across each of the secondary storages 1200.

In addition, the control device 50 may include an input unit including a keyboard, a mouse, and the like, a display unit including a liquid-crystal display device that displays data, and the like. Further, the control device 50 includes the display unit and may also include a notification unit such as a lamp or a speaker that outputs sound, particularly an alarm sound.

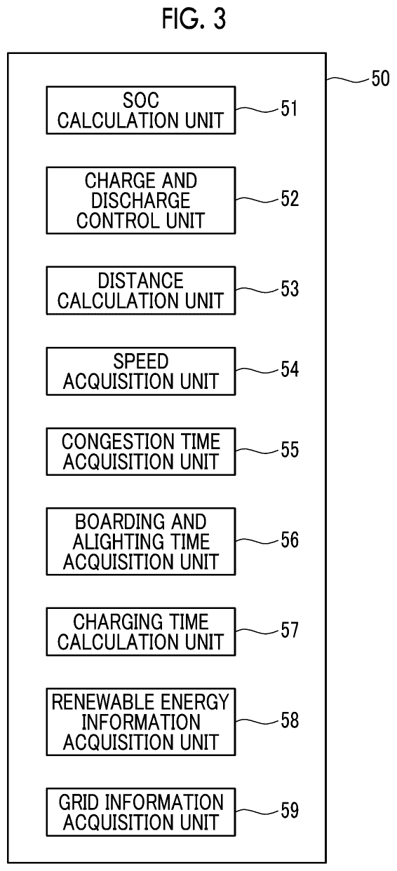

FIG. 3 is a diagram showing an example of a function of the control device in some embodiments of the present disclosure.

As shown in FIG. 3, the control device 50 includes an SOC calculation unit 51, a charge and discharge control unit 52, a distance calculation unit 53, a speed acquisition unit 54, a congestion time acquisition unit 55, a boarding and alighting time acquisition unit 56, a charging time calculation unit 57, a renewable energy information acquisition unit 58, and a grid information acquisition unit 59.

A series of processes for implementing functions of the control device 50 is stored in the secondary storage 1200 (refer to FIG. 2) or the like in the form of a program as an example, and the CPU (processor) 1100 (refer to FIG. 2) reads the program into the main memory 1300 (refer to FIG. 2) to execute information processing and calculation processing, thereby implementing various functions. The program may be provided in various forms, such as being installed in the secondary storage 1200 in advance, stored in another non-transitory computer-readable storage medium, or distributed through wired or wireless communication means. Examples of the non-transitory computer-readable storage medium include a magnetic disk, a magneto-optical disk, a CD-ROM, a DVD-ROM, a semiconductor memory, and the like.

The SOC calculation unit 51 shown in FIG. 3 calculates an SOC of the storage battery 35 of the moving body 30. The SOC of the storage battery 35 is calculated using at least one of an output of the distance calculation unit 53, and each output of the speed acquisition unit 54, the congestion time acquisition unit 55, the boarding and alighting time acquisition unit 56, and the charging time calculation unit 57, which will be described below.

The charge and discharge control unit 52 performs control such that the storage battery 35 is charged from the grid 12 or the power storage device 20 based on the SOC of the storage battery 35 calculated by the SOC calculation unit 51.

The distance calculation unit 53 calculates an operation distance of the moving body 30 to the next charging station 13 where the storage battery 35 is to be charged. The distance calculation unit 53 predicts a discharge amount of the storage battery 35 based on the operation distance to the next charging. The discharge amount predicted based on the operation distance is used as a reference charging amount for the charging at the next charging station 13, and this is denoted by a reference charging amount E base. The distance calculation unit 53 collaborates with map data to calculate the operation distance to the next charging station 13 where the storage battery 35 is to be charged. In addition, an operation time in a case where the operation is conducted at a predetermined average speed (reference speed) for the operation distance is denoted by a reference time t_base. The reference time t_base may be set based on information other than the speed or may be set by a user as desired.

The speed acquisition unit 54 acquires an operation speed of the moving body 30 and calculates the average operation speed of the moving body 30. The speed acquisition unit 54 acquires a delay time in an operation route to the next charging station 13 where the storage battery 35 is to be charged, based on a deviation between the average operation speed of the moving body 30 and the reference speed (predetermined average speed) for the calculated average operation speed. In a case where the average operation speed is higher than the reference speed, the delay time is a negative value. The delay time based on the average operation speed with respect to the reference charging amount E_base is denoted by a correction coefficient t_V.

The congestion time acquisition unit 55 collaborates with congestion information sources such as traffic control centers to acquire a congestion time that is the delay time (standby time) due to congestion in the operation route of the moving body 30 to the next charging station 13 where the storage battery 35 is to be charged, from congestion information in the operation route. The congestion time with respect to the reference charging amount E_base is denoted by a correction coefficient t_jam.

The boarding and alighting time acquisition unit 56 calculates the expected number of passengers in the operation route of the moving body 30, using past data indicating the number of passengers considering factors such as weather, calendar days, and weekdays, or an artificial intelligence (AI) function, and calculates and acquires a boarding and alighting time in the operation route to the next charging station 13 where the storage battery 35 is to be charged, based on the expected number of passengers. The boarding and alighting time with respect to the reference charging amount E_base is denoted by a correction coefficient t_inout.

The charging time calculation unit 57 calculates a charging time, which is a time during which the moving body 30 can stop at the charging station 13, that is, a time during which the storage battery 35 can be charged. The charging time with respect to the reference charging amount E_base is denoted by a correction coefficient t_ct.

The renewable energy information acquisition unit 58 acquires power generation amount information of the renewable energy 11 associated with the charging station 13. In a case where the renewable energy 11 is solar power generation, power generation is limited to daytime, and the power generation amount is affected by the weather. The renewable energy information acquisition unit 58 may collaborate with weather forecast information to predict the power generation amount of the renewable energy 11.

The grid information acquisition unit 59 acquires grid voltage and frequency information of the grid 12.

The SOC calculation unit 51 corrects the reference charging amount E_base using each of the correction coefficients t_v, t_jam, t_inout, and t_ct to calculate a required charging amount E_charge.

An amount of power (required charging amount) E_charge for the charging at the next charging station 13 where the storage battery 35 is to be charged is represented by Equation (1).

E_charge=E_base*((t_base+t_v+t_jam+t_inout+t_ct)/t_base) (1)

In Equation (1), at least one of the correction coefficients t_v, t_jam, t_inout, and t_ct may be used.

Additionally, SOC_act, which is the SOC of the storage battery 35 in a case where the storage battery 35 is charged by the required charging amount E_charge, is represented by Equation (2).

SOC_act=E_charge/E_max (2)

In Equation (2), E_max represents electric energy stored in the storage battery when the storage battery 35 is fully charged. Full charging indicates that the SOC is 100%.

The charge and discharge control unit 52 performs control such that the storage battery 35 is charged from the grid 12 or the power storage device 20 in accordance with the SOC act, which is the SOC of the storage battery 35 calculated by the SOC calculation unit 51.

The charge and discharge control unit 52 determines whether to charge the storage battery 35 using the grid 12 or the power storage device 20, based on the power generation amount information of the renewable energy 11 acquired by the renewable energy information acquisition unit 58, the grid voltage and the frequency information of the grid 12 acquired by the grid information acquisition unit 59, and the storage amount of the power storage device 20 of each charging station 13.

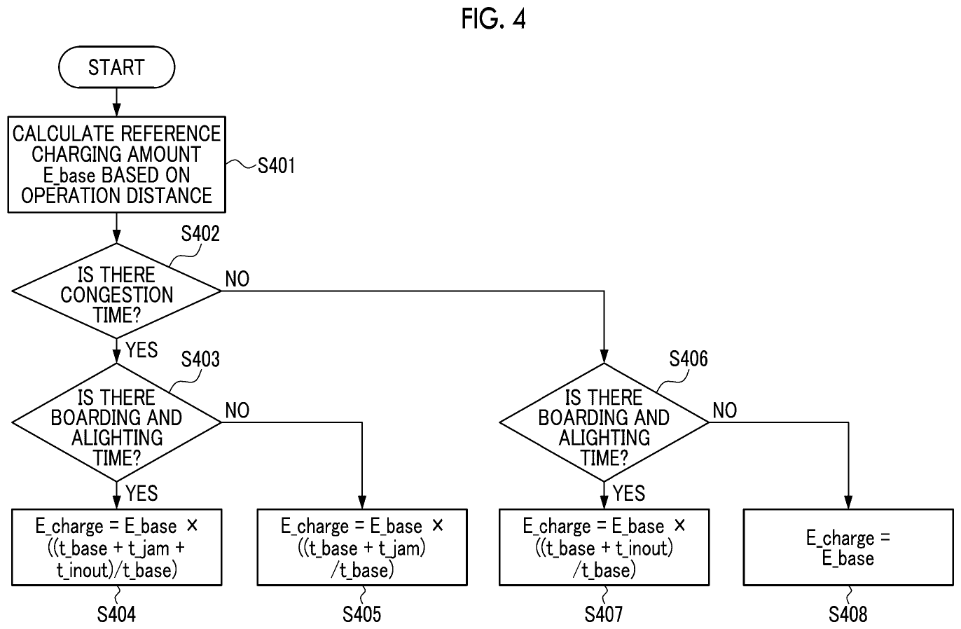

FIG. 4 is a control flowchart of the control device 50 in some embodiments of the present disclosure. Specifically, FIG. 4 is a diagram showing an example of a flowchart for calculating the required charging amount E_charge of the storage battery 35. In FIG. 4, for example, whether or not there is a congestion time and whether or not there is a boarding and alighting time are determined to calculate the required charging amount E_charge. Even in a case where whether or not there is a delay time based on the average operation speed and whether or not there is a charging time are determined, the same determination need only be performed.

The distance calculation unit 53 of the control device 50 calculates the operation distance of the moving body 30 to the next charging station 13 where the storage battery 35 is to be charged. The distance calculation unit 53 considers the discharge amount predicted based on the operation distance as the reference charging amount for the charging at the next charging station 13 and sets the discharge amount as the reference charging amount E_base (S401).

In step S402, it is determined whether or not there is a congestion time acquired by the congestion time acquisition unit 55. In a case where a delay time due to congestion occurs, the process transitions to step S403. On the other hand, in a case where no delay time due to congestion occurs, the process transitions to step S406.

In step S403, it is determined whether or not there is a boarding and alighting time acquired by the boarding and alighting time acquisition unit 56. In a case where a delay time due to the boarding and alighting of the passengers occurs, the process transitions to step S404. On the other hand, in a case where no delay time due to the boarding and alighting of the passengers occurs, the process transitions to step S405.

In step S404, in a case where the congestion time and the boarding and alighting time are present, the reference charging amount E_base is corrected using the correction coefficients t_jam and t_inout, and the required charging amount E_charge is calculated as in Equation (3).

E_charge=E_base*((t_base+t_jam+t_inout)/t_base) (3)

In step S405, in a case where only the congestion time is present, the reference charging amount E_base is corrected using the correction coefficient t_jam, and the required charging amount E_charge is calculated as in Equation (4).

E_charge=E_base*(t_base+t_jam)/t_base) (4)

In step S406, it is determined whether or not there is a boarding and alighting time acquired by the boarding and alighting time acquisition unit 56. In a case where a delay time due to the boarding and alighting of the passengers occurs, the process transitions to step S407. On the other hand, in a case where no delay time due to the boarding and alighting of the passengers occurs, the process transitions to step S408.

In step S407, in a case where only the boarding and alighting time is present, the reference charging amount E_base is corrected using the correction coefficient t_inout, and the required charging amount E_charge is calculated as in Equation (5).

E_charge=E_base*(t_base+t_inout)/t_base) (5)

In step S408, in a case where neither the congestion time nor the boarding and alighting time is present, the required charging amount E_charge is calculated as in Equation (6).

E_charge=E_base (6)

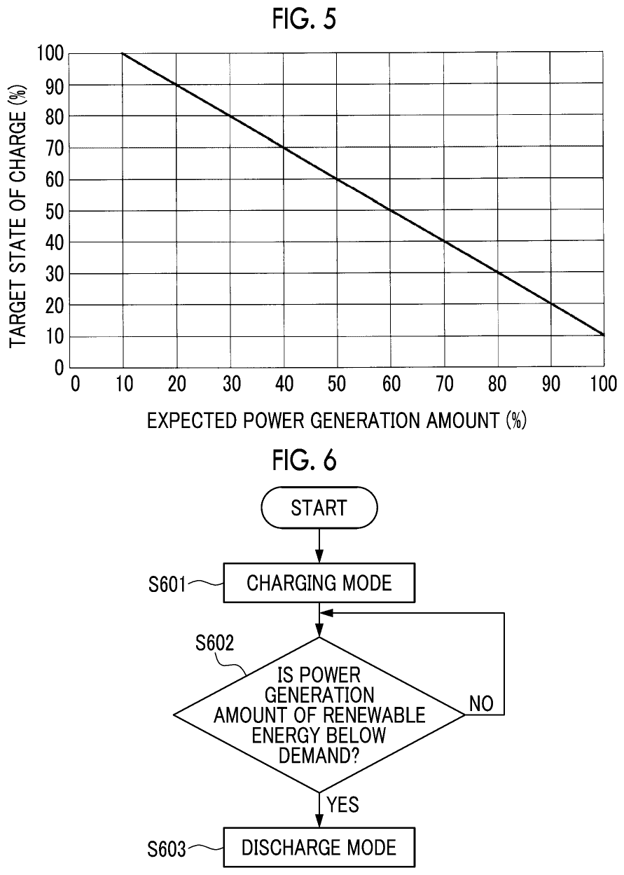

FIG. 5 is a graph showing a relationship between the power generation amount of the renewable energy and a target state of charge in some embodiments of the present disclosure.

In FIG. 5, the vertical axis represents the target state of charge of the power storage device 20, and the horizontal axis represents the expected power generation amount of the renewable energy 11 (a percentage of the expected power generation amount of the renewable energy with respect to the maximum power generation amount. Both the target state of charge and the expected power generation amount are indicated in % (percentage). As shown by a solid line in FIG. 5, a target storage rate decreases as the expected power generation amount increases, that is, the graph shows a downward trend from left to right.

The power storage device 20 of the present embodiment is charged using the renewable energy 11. Specifically, the surplus power from the renewable energy 11 is delivered to the charging station 13 through the grid 12. Consequently, the storage battery 35 of the moving body 30 and the power storage device 20 can be charged at a low electricity rate.

The power generation amount of the renewable energy 11 is predicted in advance through the power generation amount prediction. For example, the expected power generation amount changes depending on the weather.

The target state of charge of the power storage device 20 is set to 10% in a case where the expected power generation amount of the renewable energy 11 is 100%, the target state of charge is increased as the expected power generation amount decreases, and the target state of charge is set to 100% in a case where the expected power generation amount is 10%. In this manner, in a case where it is predicted that the expected power generation amount will be low, the storage battery 35 of the moving body 30 or the power storage device 20 is charged at night in advance to compensate for this. On the other hand, in a case where it is predicted that the expected power generation amount will be high, it is anticipated that daytime charging will be possible (the power generated by the renewable energy 11 will cover the required power), and the charging of the power storage device 20 is kept low.

FIG. 6 is a diagram showing an example of a control flowchart of the control device in some embodiments of the present disclosure, specifically, a flowchart of charge and discharge control of the power storage device 20.

The power generation amount of the renewable energy 11 increases or decreases depending on the weather or the like. In addition, the power demand of a plurality of moving bodies 30 increases or decreases depending on a time slot, weather, the number of passengers, or the like. The power storage device 20 is used to eliminate a deviation between the power generation amount of the renewable energy 11 and the power demand of the plurality of moving bodies 30.

The power storage device 20 is charged through the grid 12 in a charging mode in which charging is performed from the renewable energy 11 (S601). Consequently, the power storage device 20 is operated at a high SOC (the required SOC can be satisfied). Additionally, the storage battery 35 of the moving body 30 on standby may also be charged from the renewable energy 11 through the grid 12.

In step S602, the control device 50 determines whether or not the power generation amount of the renewable energy 11 is below the power demand of the plurality of moving bodies 30. In a case where it is determined that the power generation amount of the renewable energy 11 is below the demand, the process transitions to step S603. On the other hand, in a case where it is determined that the power generation amount of the renewable energy 11 is not below the demand, that is, the power generation amount of the renewable energy 11 exceeds or is equal to the demand, the determination in step S602 is performed again.

In step S602, in a case where it is determined that the power generation amount of the renewable energy 11 is below the demand, the power storage device 20 discharges power by switching to a discharge mode in which the storage battery 35 of the moving body 30 is charged through the charging station 13 (S603). In addition, the storage battery 35 of the moving body 30 on standby may discharge power to the storage battery 35 of another moving body 30.

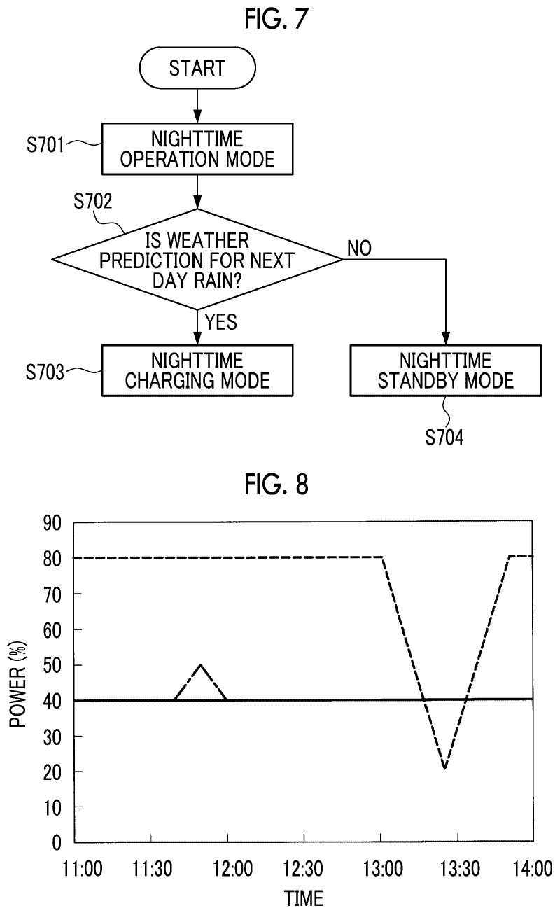

FIG. 7 is a diagram showing a control flowchart of the control device in some embodiments of the present disclosure.

Most of the moving bodies 30 are on standby during the night (late-night hours) and are often charged for the operations of the next day. For the power storage device 20, since the discharging to the moving body 30 decreases, the following control is performed.

Since the number of moving bodies 30 in operation decreases at night, the power storage device 20 switches to a nighttime operation mode (S701).

In step S702, the control device 50 determines whether or not the weather prediction for the next day is rain. In a case where it is determined that the weather prediction for the next day is rain, the process transitions to step S703. On the other hand, in a case where it is determined that the weather prediction for the next day is not rain, the process transitions to step S704. In the determination in step S702, the power generated by the renewable energy 11 need only be predicted, and determination may be made, for example, based on expected sunshine hours and the like.

In a case where it is determined that the weather prediction for the next day is rain, little power generation from the renewable energy 11 is anticipated for the next day. Therefore, the power storage device 20 switches to a nighttime charging mode and is charged using inexpensive nighttime power (S703). Additionally, the storage battery 35 of the moving body 30 on standby may also be charged from the grid 12.

In a case where it is determined that the weather prediction for the next day is not rain, it is anticipated that the renewable energy 11 will generate power and supply power smoothly on the next day. Therefore, the power storage device 20 switches to a nighttime standby mode and remains on standby without being charged (S704).

This control pertains to determination in control in a case where the renewable energy 11 is solar power generation. For example, in a case where the renewable energy 11 is wind power generation, the power generated by the renewable energy 11 need only be predicted such as determination being made based on wind volume prediction, and the determination method can be changed according to the type of power generation source.

FIG. 8 is a graph showing the power generation amount of the renewable energy and the demanded power amount of the storage battery in some embodiments of the present disclosure.

In FIG. 8, the vertical axis represents the amount of power (%), and the horizontal axis represents time. In addition, a solid line in FIG. 8 indicates the demanded power amount of the plurality of moving bodies 30, a dashed line indicates the power generation amount of the renewable energy 11, and an alternating long and short dashed line indicates the charging amount of the moving body 30 that is determined based on the expected power generation amount of the renewable energy 11. The demanded power amount of the moving bodies 30 is assumed to be almost constant and fluctuates around 40%.

As shown in FIG. 8, for example, it is predicted that the power generation amount of the renewable energy 11 will sharply decrease during the time slot from 13:00 to 14:00. In a case where the renewable energy 11 is solar power generation, for example, a rain cloud radar can be used for weather prediction, and the power generation amount can be predicted based on the most recent prediction.

In a case where it is predicted that the expected power generation amount of the renewable energy 11 will sharply decrease and the expected power generation amount is below the demanded power amount of the plurality of moving bodies 30, the power may be insufficient. Therefore, in a case where it is predicted that the expected power generation amount will sharply decrease, the storage battery 35 of the moving body 30 or the power storage device 20 is charged from the grid 12 in advance. As shown by the alternating long and short dashed line in FIG. 8, the storage battery 35 of the moving body 30 or the power storage device 20 is charged with more power amount than the demanded power amount (for example, 50%) during the time slot from 11:30 to 12:00. During the time slot when the power generated by the renewable energy 11 is below the demand, the moving body 30 may travel using the charging power of the storage battery 35 charged in advance, or the storage battery 35 may be charged from the power storage device 20 of the charging station 13.

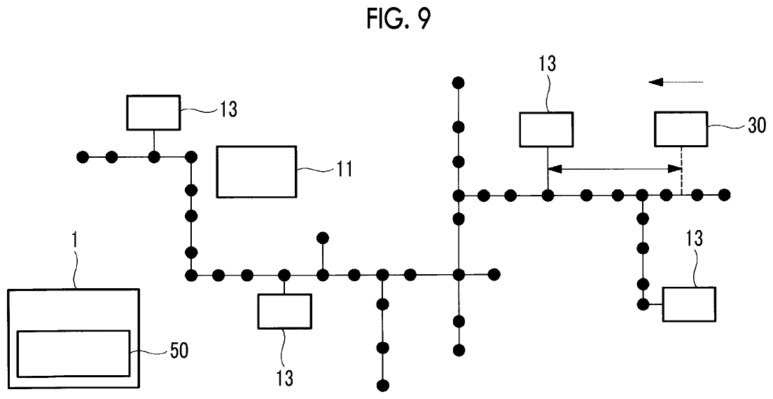

FIG. 9 is a schematic diagram showing the route of the moving body and the position of the power storage device in some embodiments of the present disclosure.

In FIG. 9, a circle mark indicates a stop of the moving body 30, and a solid line connecting the circle marks indicates the route of the moving body 30. As shown in FIG. 9, the charging station 13 is provided at a plurality of stops on the route. Additionally, the renewable energy 11 is provided in the vicinity of the route, but the renewable energy 11 may be provided at a place away from the route. However, in order to efficiently transmit power from the renewable energy 11, it is preferable that the renewable energy 11 is provided in the vicinity of the route. In accordance with a predetermined operation route, the moving body 30 travels along the route and makes arrivals and departures at the stops.

The operations of the plurality of moving bodies 30 traveling along the route are managed by an operation management system 1. The operation management system 1 determines the operation routes of the plurality of moving bodies 30 in advance. Since the operation management of the moving body 30 also includes the management of charging and discharging of the storage battery 35 of the moving body 30, the operation management system 1 is provided with the control device 50.

The operation management system 1 monitors and acquires the current positions of a plurality of moving bodies 30 that are traveling and the current positions of a plurality of moving bodies 30 that are on standby.

In a case where a time slot is predicted in which the power generation amount of the renewable energy 11 is below the demanded power amount of the plurality of moving bodies 30, the control device 50 switches the power storage device 20 to the discharge mode (steps S602 and S603 in FIG. 6). The operation management system 1 decides on the next charging station 13 where the storage battery 35 is to be charged, based on the current position of the moving body 30 that is traveling, and calculates the charging prediction time, which is the time when the charging of the storage battery 35 will next be required, and the expected demanded power amount of the storage battery 35, based on the distance from the current position of the moving body 30 to the charging station 13.

The power storage device 20 of the decided-on charging station 13 is charged in advance as shown in FIG. 8 based on the power generation amount prediction of the renewable energy 11 and the operation schedule of the moving body 30, that is, information such as the charging prediction time and the expected demanded power amount from the operation management system 1, thereby enabling power to be smoothly discharged to the storage battery 35 of the moving body 30.

In addition, the storage battery 35 of the moving body 30 degrades due to repeated charging and discharging, but the degree of degradation progress is known to change depending on various factors. Regarding the degradation of the storage battery 35, each factor of the average operation speed, the congestion time, the boarding and alighting time, and the charging time contributes, and each factor varies depending on each route on which the moving body 30 operates.

Regarding the average operation speed, in a case where the speed is high, a large amount of current is discharged in a short time, which increases the amount of heat generation and accelerates the degradation of the storage battery 35.

Regarding the congestion time, in a case where a congestion occurs at a place close to the charging station 13 where the moving body 30 has been charged, the moving body 30 remains on standby at a high SOC, which degrades storage properties and accelerates the degradation of the storage battery 35. The congestion time acquisition unit 55 collaborates with the congestion information source to acquire a congestion position where a congestion has occurred, together with the congestion time. In the present embodiment, it is assumed that the congestion time includes the congestion position.

Regarding the boarding and alighting time, in a case where the number of passengers increases at a place close to the charging station 13 where the moving body 30 has been charged, the moving body 30 remains on standby at a high SOC, which degrades storage properties and accelerates the degradation of the storage battery 35. The boarding and alighting time acquisition unit 56 acquires the boarding and alighting position and the expected number of passengers calculated using the past data of the number of passengers and the AI function, together with the boarding and alighting time. In the present embodiment, the boarding and alighting time includes the expected number of passengers and the boarding and alighting position.

Regarding the charging time, in a case where the moving body 30 cannot allocate a sufficient time for charging at the charging station 13, that is, in a case where the operation schedule is too tight, a large amount of current is charged in a short time, which increases the amount of heat generation and accelerates the degradation of the storage battery 35.

The operation management system 1 calculates the degradation rate of each route based on at least one of the average operation speed, the congestion time, the boarding and alighting time, and the charging time.

The operation management system 1 changes the allocation of the moving body 30 to the route based on the degradation rate of each route and manages the operation schedule of the moving body 30. The operation management system 1 manages the operation of the moving body 30 based on a degree of degradation (state of health (SOH), an index indicating a degradation state of a battery) of each storage battery 35.

The operation management system 1 calculates the average SOH of all the moving bodies 30, and changes the moving body 30 including the storage battery 35 having a lower SOH than the average SOH (higher degree of degradation) to a route with a lower degradation rate or suspends the operation of the moving body 30. The route with a lower degradation rate is a route where the degradation of the storage battery 35 of the moving body 30 that operates on the route tends to be slower. In a case where the storage battery 35 can be replaced from the moving body 30, only the storage battery 35 may be changed to the route with a lower degradation rate. For example, in a case where the SOH of the storage battery 35 is 4% lower than the average SOH, assuming that a design life of the storage battery 35 is 15 years and a permissible SOH is 70% or more, the storage battery 35 can be considered to have degraded by approximately 2 years. An operation on a route with slower degradation (a route with a lower degradation rate) results in a longer lifespan of the storage battery 35 because the SOH of the storage battery 35 is higher as compared to an operation on a route with faster degradation (a route with a higher degradation rate). The route with a lower degradation rate is, for example, a route where the average operation speed is lower, the congestion position or the boarding and alighting position (stop) with many passengers is located farther from the charging station 13, the operation schedule is dispersed, and the operation distance is shorter. By being reallocated to a route where the operation schedule is dispersed or a route where the operation distance is shorter, the storage battery 35 can secure longer charging and standby times.

The operation management system 1 may assign a priority based on the SOH of each storage battery 35 and manage the operation of the moving body 30 in accordance with the priority. The operation management system 1 performs optimization such that the degradation of each storage battery 35 is uniform, resulting in a longer lifespan for all the storage batteries 35.

### Supplementary Notes

The control device, the operation management system, the control method, and the control program described in the embodiment described above are understood as follows, for example.

According to a first aspect of the present disclosure, there is provided a control device (50) that controls charging of a storage battery (35) for driving a motor of a moving body (30) with a predetermined operation route, the storage battery being provided in the moving body, the control device including: a distance calculation unit (53) that calculates an operation distance to a destination of the moving body; a speed acquisition unit (54) that acquires an average operation speed of the moving body; a congestion time acquisition unit (55) that acquires a predicted congestion time; a boarding and alighting time acquisition unit (56) that acquires a predicted boarding and alighting time; and a charging time calculation unit (57) that calculates a charging time required to charge the storage battery, in which a reference charging amount is calculated based on the operation distance, the reference charging amount is corrected based on at least one of the average operation speed, the congestion time, the boarding and alighting time, and the charging time to calculate a required charging amount, and a state of charge of the storage battery is calculated based on the required charging amount, and control is performed such that the storage battery is charged to the state of charge from a stationary power storage device (20) or a grid (12).

The storage battery of the moving body is charged to the state of charge corresponding to the required charging amount, which is the required minimum charging amount, rather than being fully charged, thereby making it possible to suppress a rate of degradation of the storage battery. In addition, since the required charging amount is corrected and calculated based on at least one of the average operation speed, the congestion time, the boarding and alighting time, and the charging time, the required charging amount can be set to a more accurate value.

According to a second aspect of the present disclosure, in the control device according to the first aspect, the stationary power storage device may be charged using renewable energy (11).

As a result, the power from the variable renewable energy can be quantified by using the stationary power storage device that charges the moving body. Additionally, it is possible to operate the moving body with consideration for the environment.

According to a third aspect of the present disclosure, in the control device according to the second aspect, the storage battery of the moving body may be charged from the stationary power storage device during a time slot when power consumption is higher than during other time slots.

As a result, the power obtained through advance charging from the renewable energy can be used during the time slot when the power consumption is higher, and even when the demand exceeds the power generation amount during the time slot when the power consumption is higher, the power supply corresponding to the demand can be performed.

According to a fourth aspect of the present disclosure, in the control device according to the second or third aspect, charging and discharging of the stationary power storage device may be performed based on a power generation amount prediction of the renewable energy and an operation schedule of the moving body.

As a result, the stationary power storage device can be charged in accordance with the trends in power consumption, such as charging the stationary power storage device using surplus power during a time slot when the power generation amount of the renewable energy is large or charging the stationary power storage device in advance prior to the time slot when the power consumption of the moving body is higher.

According to a fifth aspect of the present disclosure, there is provided an operation management system (1) including: the control device according to any one of the first to fourth aspects, in which operations of a plurality of moving bodies with predetermined operation routes are managed.

According to a sixth aspect of the present disclosure, in the operation management system according to the fifth aspect, in a case where a degree of degradation of the storage battery of the moving body is high, the moving body may be changed to an operation route with a lower degradation rate, or the operation of the moving body may be suspended.

As a result, in a case where the degradation rate of the storage battery is high, the moving body is changed to the operation route with a lower degradation rate, or the operation is suspended, thereby making it possible to reduce the degradation rate and average the degradation rates of the storage batteries of the plurality of moving bodies.

According to a seventh aspect of the present disclosure, in the operation management system according to the sixth aspect, the degradation rate of each of the operation routes may be calculated based on at least one of the average operation speed, the congestion time, the boarding and alighting time, and the charging time in the operation route, and the operation of the moving body may be managed based on each degradation rate.

As a result, the degradation rate of the storage battery of the moving body can be set to a more accurate value, and highly accurate management is possible, thereby further averaging the degradation rates of the storage batteries of the plurality of moving bodies.

According to an eighth aspect of the present disclosure, there is provided a control method (50) of controlling charging of a storage battery provided in a moving body with a predetermined operation route, the control method being executed by a computer, including: a distance calculation step of calculating an operation distance to a destination of the moving body; a speed acquisition step of acquiring an average operation speed of the moving body; a congestion time acquisition step of acquiring a predicted congestion time; a boarding and alighting time acquisition step of acquiring a predicted boarding and alighting time; and a charging time calculation step of calculating a charging time required to charge the storage battery, in which a reference charging amount is calculated based on the operation distance, the reference charging amount is corrected based on at least one of the average operation speed, the congestion time, the boarding and alighting time, and the charging time to calculate a required charging amount, and a state of charge of the storage battery is calculated based on the required charging amount, and control is performed such that the storage battery is charged to the state of charge from a stationary power storage device or a grid.

According to a ninth aspect of the present disclosure, there is provided a control program (50) for causing a computer to execute the control method according to the eighth aspect.

### REFERENCE SIGNS LIST

1: operation management system
10: charging and discharging system
11: renewable energy
12: grid
13: charging station
20: power storage device (stationary power storage device)
30: moving body
35: storage battery
50: control device
51: SOC calculation unit
52: charge and discharge control unit
53: distance calculation unit
54: speed acquisition unit
55: congestion time acquisition unit
56: boarding and alighting time acquisition unit
57: charging time calculation unit
58: renewable energy information acquisition unit
59: grid information acquisition unit
1100: CPU
1200: secondary storage
1300: main memory
1500: communication unit
1800: bus

1. A control device that controls charging of a storage battery for driving a motor of a moving body with a predetermined operation route, the storage battery being provided in the moving body, the control device comprising:
a distance calculation unit that calculates an operation distance to a destination of the moving body;
a speed acquisition unit that acquires an average operation speed of the moving body;
a congestion time acquisition unit that acquires a predicted congestion time;
a boarding and alighting time acquisition unit that acquires a predicted boarding and alighting time; and
a charging time calculation unit that calculates a charging time required to charge the storage battery,
wherein a reference charging amount is calculated based on the operation distance, the reference charging amount is corrected based on at least one of the average operation speed, the congestion time, the boarding and alighting time, and the charging time to calculate a required charging amount, and
a state of charge of the storage battery is calculated based on the required charging amount, and control is performed such that the storage battery is charged to the state of charge from a stationary power storage device or a grid.

2. The control device according to claim 1,
wherein the stationary power storage device is charged using renewable energy.

3. The control device according to claim 2,
wherein the storage battery of the moving body is charged from the stationary power storage device during a time slot when power consumption is higher than during other time slots.

4. The control device according to claim 2,
wherein charging and discharging of the stationary power storage device is performed based on a power generation amount prediction of the renewable energy and an operation schedule of the moving body.

5. An operation management system comprising:
the control device according to claim 1,
wherein operations of a plurality of moving bodies with predetermined operation routes are managed.

6. The operation management system according to claim 5,
wherein, in a case where a degree of degradation of the storage battery of the moving body is high, the moving body is changed to an operation route with a lower degradation rate, or the operation of the moving body is suspended.

7. The operation management system according to claim 6,
wherein the degradation rate of each of the operation routes is calculated based on at least one of the average operation speed, the congestion time, the boarding and alighting time, and the charging time in the operation route, and the operation of the moving body is managed based on each degradation rate.

8. A control method of controlling charging of a storage battery provided in a moving body with a predetermined operation route, the control method being executed by a computer, comprising:
a distance calculation step of calculating an operation distance to a destination of the moving body;
a speed acquisition step of acquiring an average operation speed of the moving body;
a congestion time acquisition step of acquiring a predicted congestion time;
a boarding and alighting time acquisition step of acquiring a predicted boarding and alighting time; and
a charging time calculation step of calculating a charging time required to charge the storage battery,
wherein a reference charging amount is calculated based on the operation distance, the reference charging amount is corrected based on at least one of the average operation speed, the congestion time, the boarding and alighting time, and the charging time to calculate a required charging amount, and
a state of charge of the storage battery is calculated based on the required charging amount, and control is performed such that the storage battery is charged to the state of charge from a stationary power storage device or a grid.

9. A non-transitory computer readable medium storing a control program for causing a computer to execute the control method according to claim 8.
